(19) United States
(12) Patent Application Publication
(10) Pub. No.: US 2001/0043374 A1
(43) Pub. Date: Nov. 22, 2001

(54) APPARATUS AND METHOD FOR AUTOMATICALLY STARTING AN IMAGE PICKUP APPARATUS

(76) Inventors: JOHN LIN, HSINCHU (TW); WEN-REN YANG, HSINCHU (TW)

Correspondence Address: LACKENBACH SIEGEL MARZULLO ARONSON, AND GREENSPAN, ONE CHASE RD, SCARSDALE, NY, 10583

(21) Appl. No.: 08/898,951

(22) Filed: Jul. 23, 1997

(51) Int. Cl. H04N 1/04; G06K 1/00

(52) U.S. Cl. 358/497; 358/401

(57) ABSTRACT

An apparatus and a method are disclosed for automatically starting an image-pickup apparatus having an upper cover and a scanning flat for putting an object to be scanned thereon. The apparatus includes: (a) a detector generating a triggering signal in response to a closing operation of the upper cover; and (b) a recognition device detecting the presence of the object on the scanning flat in response to the triggering signal to generate an actuating signal to have the image-pickup apparatus perform a pickup operation of an image of the object.

### FIELD OF THE INVENTION

The present invention relates to an apparatus and a method for automatically starting an image-pickup apparatus, and especially relates to an apparatus and a method adapted to be used for automatically starting an image-pickup apparatus having an upper cover and a scanning flat for putting an object to be scanned thereon.

### BACKGROUND OF THE INVENTION

As the techniques of the personal computer are improved rapidly to provide powerful functions day by day, many peripheral computer products are also pupular in the market. For example, in a scanner, many patterns can be converted into digital data which can be saved for any modification and edition and a lot of written data can be saved through this way. However, it is still inconvenient for the present flatbed scanner to scan a large number of objects. The conventional operating procedures are: (a) opening the upper cover; (b) putting the object on the scanning flat; (c) closing the upper cover; and (d) starting scanning procedure (generally operated by pressing a key). Nevertheless, it needs much more time for users to scan a large number of objects. Although Taiwanese Patent No. 278761 has disclosed that the object can be automatically scanned by detecting the weight of the object, there may be more errors generated through this way.

### SUMMARY OF THE INVENTION

An object of the present invention is to provide a method which simplifies the operating procedure for scanning the objects and can detect the closing operation of the upper cover and the presence of the object simutaneously as a basis for executing the scanning procedure in order to eliminate the possibility of incorrect recognition.

Another object of the present invention is to provide an actuating device adapted to be used with an image-pickup apparatus having an upper cover and a scanning flat for putting an object to be scanned thereon.

According to the present invention, the actuating device includes: (a) a detector generating a triggering signal in response to a closing operation of the upper cover; and (b) a recognition device electrically connected to the detector and detecting a presence of the object on the scanning flat in response to the triggering signal to generate an actuating signal which enables the image-pickup apparatus to perform a pickup operation of an image of the object.

In accordance with one aspect of the present invention, the image-pickup apparatus is a flatbed scanner having the upper cover which is pivotally opened and closed, and the scanning flat.

In accordance with another aspect of the present invention, the detector includes: (1) a member mounted on the upper cover of the image-pickup apparatus; and (2) a sensor mounted on the scanning flat at a position corresponding to that of the member, and generating the triggering signal when the sensor senses the member.

In accordance with another aspect of the present invention, the member is a salient and the sensor is a chopper.

In accordance with another aspect of the present invention, the recognition device includes: (i) a pattern set on the upper cover; (ii) a discriminator electrically connected to a charge coupled device (CCD) of the image-pickup apparatus and generating the actuating signal in response to a change of the pattern detected by the charge coupled device; and (iii) a controller electrically connected to the discriminator and the sensor and generating a scan-required signal in response to both the triggering signal and the actuating signal to have the image-pickup apparatus perform the pickup operation of the image of the object.

In accordance with another aspect of the present invention, the pattern is a bar code.

In accordance with another aspect of the present invention, the pattern is a color block.

Another object of the present invention is to provide a method for automatically starting an image-pickup apparatus having an upper cover and a scanning flat for putting an object to be scanned thereon.

According to the present invention, the method includes steps of: (a) generating a triggering signal in response to a closing operation of the upper cover; and (b) detecting a presence of the object on the scanning flat in response to the triggering signal to generate an actuating signal to have the image-pickup apparatus perform a pickup operation of an image of the object.

In accordance with one aspect of the present invention, the method is applied to a flatbed scanner having the upper cover which is pivotally opened and closed and the scanning flat.

In accordance with another aspect of the present invention, in the step (a), the triggering signal is generated by a detector including: (1) a member mounted on the upper cover of the image-pickup apparatus; and (2) a sensor mounted on the scanning flat at a position corresponding to that of the member, and generating the triggering signal when the sensor senses the member.

In accordance with another aspect of the present invention, the step (b) is executed by a recognition device including: (i) a pattern set on the upper cover; (ii) a discriminator electrically connected to a charge coupled device (CCD) of the image-pickup apparatus and generating the actuating signal in response to a change of the pattern detected by the charge coupled device; and (iii) a controller electrically connected to the discriminator and the sensor and generating a scan-required signal in response to both the triggering signal and the actuating signal to have the image-pickup apparatus perform the pickup operation of the image of the object.

In accordance with another aspect of the present invention, the discriminator generates the actuating signal in response to that the charge coupled device do not receive the reflection of the pattern, masked by the object after the object is put on the scanning flat and the upper cover is closed.

In accordance with another aspect of the present invention, the method further including a step executed after the step (b): (c) generating a clear signal to the controller to have the image-pickup apparatus enter a standby state.

Another object of the present invention is to provide another embodied actuating device adapted to be used with an image-pickup apparatus having an upper cover and a scanning flat for putting an object to be scanned thereon.

The embodied actuating device includes a detector generating a triggering signal in response to a closing operation of the upper cover for automatically starting the image-pickup apparatus to perform a pickup operation of an image of the object.

The present invention may best be understood through the following description with reference to the accompanying drawings, in which:

### BRIEF DESCRIPTION OF THE DRAWINGS

FIG. 1 is a procedure of a preferred embodiment of the present invention; and

FIG. 2 is a block diagram of a circuit of a preferred embodiment of the present invention.

### DETAILED DESCRIPTION OF THE PREFERRED EMBODIMENT

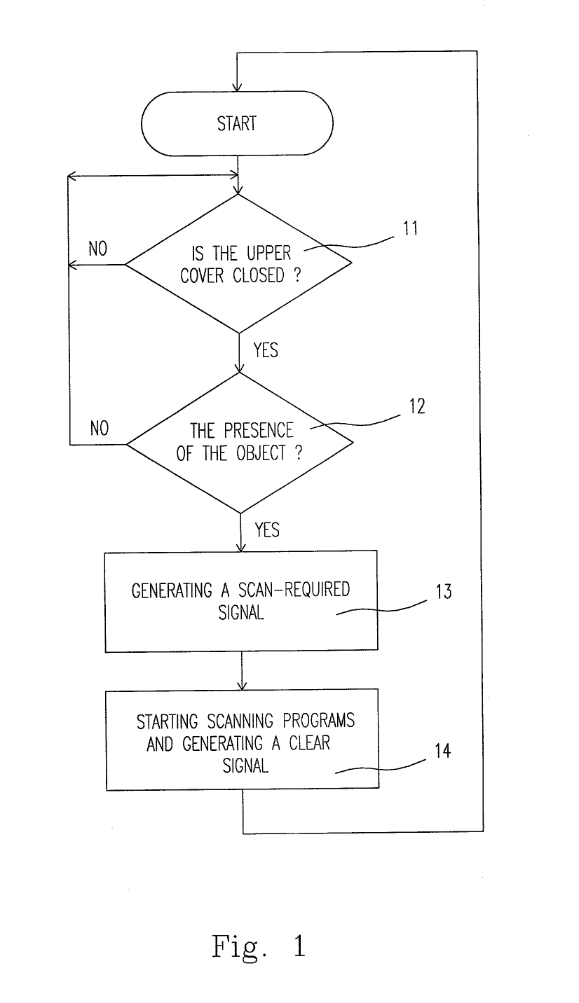

Please refer to FIG. 1 showing a procedure of a preferred embodiment of the present invention applied to a flatbed scanner. The states 11 and 12 are to detect the closing operation of the upper cover and the presence of the object repectively. If the upper cover has been closed and the object has been put on the scanning flat, the procedure enters into state 13 to generate a scan-required signal and then enters into state 14 to have the scanner scan the object by starting a scanning program and to generate a clear signal at the same time.

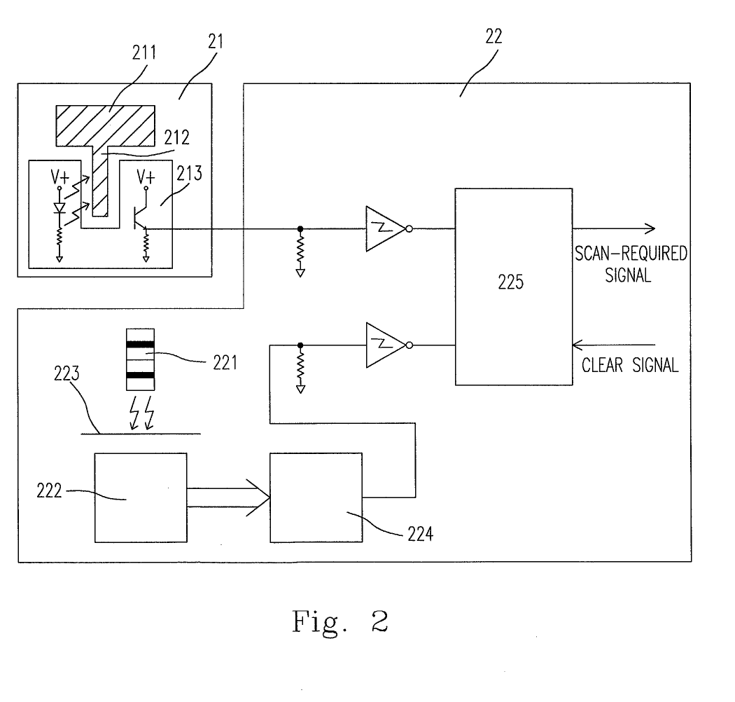

Please refer to FIG. 2 which is a block diagram of a circuit of a preferred embodiment of the present invention. The scanner has an upper cover 211 which is pivotally opened and closed and a salient 212. When the upper cover 211 is closed, the original state of the chopper 213, preset on the scanning flat, is changed when the potential of the chopper 213 is changed from high to low (that is a triggering signal). The chopper 213, triggered by the salient 212, generates the triggering signal in response to the closing operation of the upper cover 211. In addition to the chopper described above, the opening and closing operation of the upper cover can also be detected by using a reflection switch (e.g. setting a state of the photo-receptor when the upper cover is opened and/or closed) or a pressing switch (e.g. setting a state of the pressure inductor when the upper cover is opened and/or closed).

Please refer to the recognition device 22 of the preferred embobiment as shown in FIG. 2. There is a pattern 221 (a bar code or a color block) set on the upper cover. The charge coupled device (CCD) 222 detects the state of the preset pattern 221 when there is no object put on the scanning flat and the upper cover is closed. When an object 223 is put on the scanning flat, the state of CCD 222 is changed because the pattern 221 is masked by the object 223. Meanwhile, a discriminator 224 generates an actuating signal by changing the potential from high to low. When the triggering signal and the actuating signal are generated simutaneously and sent to the controller 225. the controller 225 generates a scan-required signal to have the scanner perform a pickup operation of the image of the object. Certainly, the recognition device 22 described above can use a chopper or a photo-reflector to detect the presence of the object 223.

On the other hand, during the time that the object 223 is scanned by the scanner, a clear signal is generated and sent to the controller 225 to have the scanner enter a standby state as shown in the state 14 of FIG. 1.

In conclusion, the present invention provides a method which simplifies the operating procedure for scanning the object and can detect the closing operation of the upper cover and the presence of the object simutaneously as a basis for executing the scanning procedure in order to eliminate the possibility of incorrect recognition.

In addition, the present invention also provides another embodied actuating device adapted to be used with an image-pickup apparatus having an upper cover and a scanning flat for putting an object to be scanned thereon. The embodied actuating device only includes a detector generating a triggering signal in response to a closing operation of the upper cover. After the upper cover is closed, the image-pickup apparatus automatically starts performing a pickup operation of an image of the object.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An actuating device, adapted to be used with an image-pickup apparatus having an upper cover and a scanning flat for putting an object to be scanned thereon, comprising:
a detector generating a triggering signal in response to a closing operation of said upper cover; and
a recognition device electrically connected to said detector and detecting a presence of said object on said scanning flat in response to said triggering signal to generate an actuating signal to have said image-pickup apparatus perform a pickup operation of an image of said object.

2. An actuating device according to claim 1 wherein said image-pickup apparatus is a flatbed scanner having said upper cover which is pivotally opened and closed, and said scanning flat.

3. An actuating device according to claim 1 wherein said detector includes:
a member mounted on said upper cover of said image-pickup apparatus; and
a sensor mounted on said scanning flat at a position corresponding to that of said member, and generating said triggering signal when said sensor senses said member.

4. An actuating device according to claim 3 wherein said member is a salient and said sensor is a chopper.

5. An actuating device according to claim 3 wherein said recognition device includes:
a pattern set on said upper cover;
a discriminator electrically connected to a charge coupled device (CCD) of said image-pickup apparatus and generating said actuating signal in response to a change of said pattern detected by said charge coupled device; and
a controller electrically connected to said discriminator and said sensor and generating a scan-required signal in response to both said triggering signal and said actuating signal to have said image-pickup apparatus perform said pickup operation of said image of said object.

6. An actuating device according to claim 5 wherein said pattern is a bar code.

7. An actuating device according to claim 5 wherein said pattern is a color block.

8. A method for automatically starting an image-pickup apparatus having an upper cover and a scanning flat for putting an object to be scanned thereon, comprising steps of:
(a) generating a triggering signal in response to a closing operation of said upper cover; and
(b) detecting a presence of said object on said scanning flat in response to said triggering signal to generate an actuating signal to have said image-pickup apparatus perform a pickup operation of an image of said object.

9. A method according to claim 8 being applied to a flatbed scanner having said upper cover which is pivotally opened and closed and said scanning flat.

10. A method according to claim 8 wherein in said step (a), said triggering signal is generated by a detector including:
a member mounted on said upper cover of said image-pickup apparatus; and
a sensor mounted on said scanning flat at a position corresponding to that of said member, and generating said triggering signal when said sensor senses said member.

11. A method according to claim 8 wherein said step (b) is executed by a recognition device including:
a pattern set on said upper cover;
a discriminator electrically connected to a charge coupled device (CCD) of said image-pickup apparatus and generating said actuating signal in response to a change of said pattern detected by said charge coupled device; and
a controller electrically connected to said discriminator and said sensor and generating a scan-required signal in response to both said triggering signal and said actuating signal to have said image-pickup apparatus perform said pickup operation of said image of said object.

12. A method according to claim 11 wherein said discriminator generates said actuating signal in response to that said charge coupled device do not receive the reflection of said pattern, masked by said object after said object is put on said scanning flat and said upper cover is closed.

13. A method according to claim 8 further including a step (c) executed after said step (b):
(c) generating a clear signal to said controller to have said image-pickup apparatus enter a standby state.

14. An actuating device, adapted to be used with an image-pickup apparatus having an upper cover and a scanning flat for putting an object to be scanned thereon, comprising:
a detector generating a triggering signal in response to a closing operation of said upper cover for automatically starting said image-pickup apparatus to perform a pickup operation of an image of said object.

15. An actuating device according to claim 14 wherein said image-pickup apparatus is a flatbed scanner having said upper cover which is pivotally opened and closed, and said scanning flat.

16. An actuating device according to claim 14 wherein said detector includes:
a member mounted on said upper cover of said image-pickup apparatus; and
a sensor mounted on said scanning flat at a position corresponding to that of said member, and generating said triggering signal when said sensor senses said member after said upper cover is closed.

17. An actuating device according to claim 16 wherein said member is a salient and said sensor is a chopper.
